(19) United States
(12) Patent Application Publication
(10) Pub. No.: US 2008/0214109 A1
(43) Pub. Date: Sep. 4, 2008

(54) Communication System For Short-Range Wireless Data Exchange

(75) Inventor: Sytze Hendrik Kalisvaart, Eindhoven (NL)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: Nederlandse Organisatie voor toegepast- natuurwetenschajppelijk Onderzoek TNO, Delft (NL)

(21) Appl. No.: 11/914,908

(22) PCT Filed: May 26, 2006
(86) PCT No.: PCT/NL2006/000270

§ 371 Date: Feb. 25, 2008

(30) Foreign Application Priority Data
May 26, 2005 (EP) 0507620.8

(51) Int. Cl. H04B 7/00

(52) U.S. Cl. 455/41.2

(57) ABSTRACT

Communication system, comprising cooperating modules (1, 4, 5) which are enabled to mutually exchange data via at least one short-range wireless path. Each module comprises at least one wireless termination node (2) which is arranged to be part of the relevant short-range wireless path. The housing (3) of each module comprises an external shape part (3a, 3b, 6a, 6b), which is explicitly arranged to match with corresponding shape parts of each other module. Preferably the shape parts are self complementary, so that the shape part fits with a similar shape part on another module, but alternatively each module may have two shape parts that fit cross-wise (not necessarily at the same time). The cooperating modules may comprise means which are arranged to perform a default (e.g. handshake) operation via the short-range wireless path as soon as it is detected that the cooperating modules are brought into each others vicinity. The communication system may comprise different sets (A, B) of cooperating modules. Each module of one specific set comprises a housing with an external shape which is explicitly arranged to match with the shape of other modules of the same specific set. A set specific operation may be performed as soon as modules of the same specific set are brought into each others vicinity.

### FIELD

The invention concerns a communication system, comprising at least two cooperating modules which are enabled to mutually exchange data via at least one short-range wireless path, each one of said cooperating modules comprising at least one wireless termination node which is fit to be part of the relevant short-range wireless path.

### BACKGROUND

Many people nowadays are surrounded by electronic products such as PC's and wear various mobile communication devices such as mobile phones, headsets, fitness devices (e.g. heart rate sensors and wristwatch computers) and PDA's. There is a tendency in using more and more collaborating devices, distributed over the user's body and direct environment. These products may have to communicate with each other, e.g. in a wireless manner. In general it is not always easy to establish a reliable wireless connection between the devices for an average consumer. In general, products nowadays have so many additional functions and features that there is a growing need for simpler interaction mechanisms, designed for all users (e.g. elderly, no-nonsense consumers, incidental users, children and disabled persons) with basic functionality and easy, intuitive control.

From European Patent application No. 1 271 286 a system is known with a primary terminal and a secondary terminal that can be combined with the primary terminal. The primary terminal has a mounting base in the form of a recess for the secondary terminal. The recess has a shape that corresponds to that of the secondary terminal. Sensors are provided in the primary terminal to detect insertion of the secondary terminal into the recess. When the sensors detect insertion wireless communication (e.g. bluetooth communication) is established between the primary and secondary terminals.

This approach is not intended for mere signaling that communication should start, but rather to provide for a state wherein the secondary terminal remains mounted on the primary terminal for an indefinite time. Furthermore this document assumes asymmetric roles for the primary and secondary terminals. Secondary terminals cannot be mounted onto each other without a primary terminal.

US patent application No. 2004/0137935 similarly discloses a modular system wherein different shell modules can be attached to the same core modules. Also US patent application teaches a system with a computing device and a mountable user interface.

### SUMMARY

One aim of the present invention is to meet the objections of the known systems and to present a communication system comprising a plurality of cooperating modules (e.g. mobile phones, headsets, PCs, PDAs, wrist computers, sensor devices for e.g. sport or healthcare, MP3 players, access badges and readers, laptops, keyboards, display devices, etc.) which comprise arrangements for simple, easy and intuitive operation to establish communication between any pair of the modules. Preferably, each one of the cooperating modules of the new system comprises a housing which comprises a first and second curved and/or angled external shape part which are explicitly arranged—obvious for their users—to match (physically) with the second and first curved and/or angled shape part of any other one of the cooperating modules. Thus the first shape part of one module can be fitted to the second shape part of each other module and the second shape part of one module can be fitted to the first shape part of each other module. Aim of the matching external characteristics is to facilitate and/or enhance said data exchange via the short-range wireless path or paths respectively in a user friendly and intuitive way.

In a preferred embodiment the combination of the shape parts is self-complementary, so that when each module has the same combination of shape parts, these shape parts of the module can be matched simultaneously with the same shape part of each other module (the alternative is that the first and second shape parts can be fitted only one at a time). Thus, effectively the first and second shape part form one self-complementary shape part. Mathematically speaking self complementarity means that by a rotation transformation the shape part can be mapped onto itself in such a way that the inside of the housing is on mutually opposite sides in the mapped shape part and the original shape part.

The modules are provided with a detection arrangement to detect when the shape parts of a pair of the modules have been brought into matching positions. In response to the detection the modules establish wireless communication. A module with a self complementary shape part is able to provide a detection already with one sensor. Preferably a non-contact detection arrangement is used, so that no exact contact is needed to trigger communication. Preferably, the external characteristic of the housing and the location of the wireless node or nodes are arranged thus that, when bringing said cooperating modules into each others (physical) vicinity, the wireless node or nodes of said cooperating modules match too, thus enhancing the data exchange via the short-range wireless path(s). The cooperating modules may e.g. comprise bidirectional and/or unidirectional nodes. The cooperating modules may e.g. comprise infrared (IR), radio frequent (RF) and/or inductive nodes, e.g. comprising electromagnetic loops or coils.

Moreover, the cooperating modules may comprise means (implemented in hardware and/or software) which are arranged to perform at least one default operation (or a default set of operations) via the relevant short-range wireless path or paths as soon as said cooperating modules are brought into each others vicinity. For instance, an automatic handshake operation may be performed, e.g. including the exchange of a default set of data, e.g. address data like telephone numbers or business card data.

The communication system may comprise different sets of (two or more) cooperating modules, each one of the cooperating modules of one specific set comprising a housing which comprises an external shape which is explicitly arranged—and intuitively obvious for the users—to match with shapes of all other ones of the cooperating modules of the same specific set. In this way different module clusters may be formed of mutual compatible modules, together establishing a dedicated subsystem. It may be preferred that each one of the cooperating modules of one specific set (or subsystem) comprises (hardware and/or software) means which are arranged to perform a default operation or default operations set as soon as said cooperating modules of the same specific set are brought into each others vicinity. The relevant default operation or default operations set preferably is representative for the relevant specific set of cooperating modules or, in other words, the relevant subsystem.

### EXEMPLARY EMBODIMENT

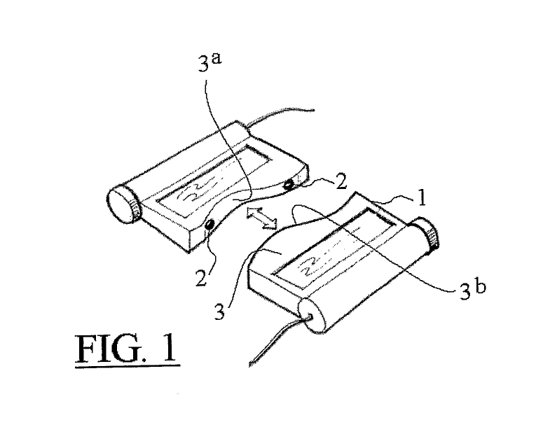

FIG. 1 shows a couple of cooperating communication modules.

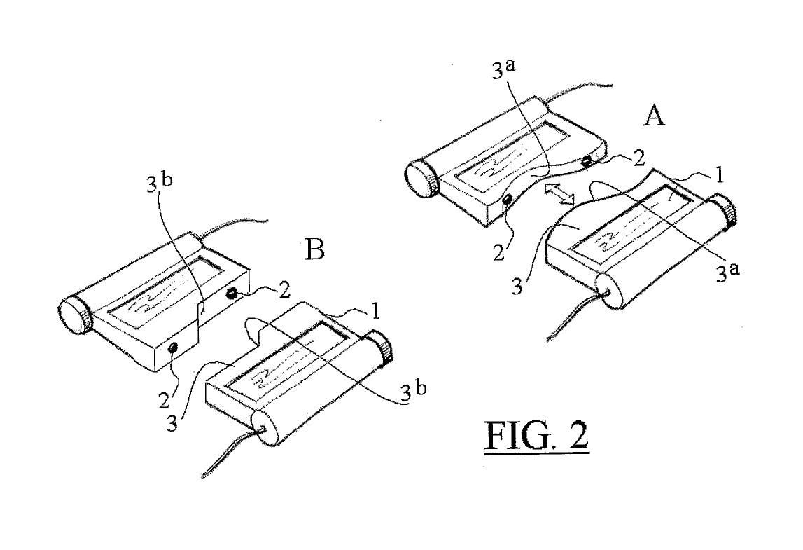

FIG. 2 shows a communication system, comprising two subsystems, each formed by two modules having equal shapes.

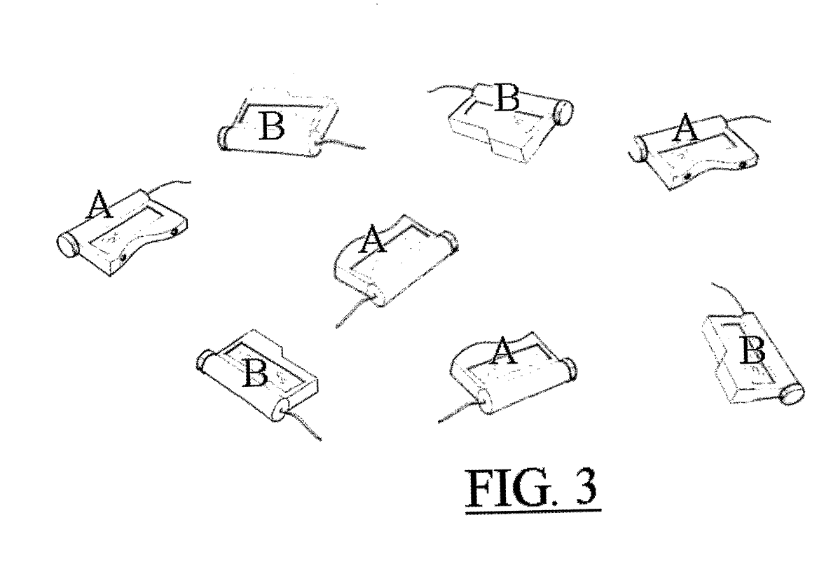

FIG. 3 shows a communication system, comprising two subsystems, formed by two sets of modules having mutual different shapes.

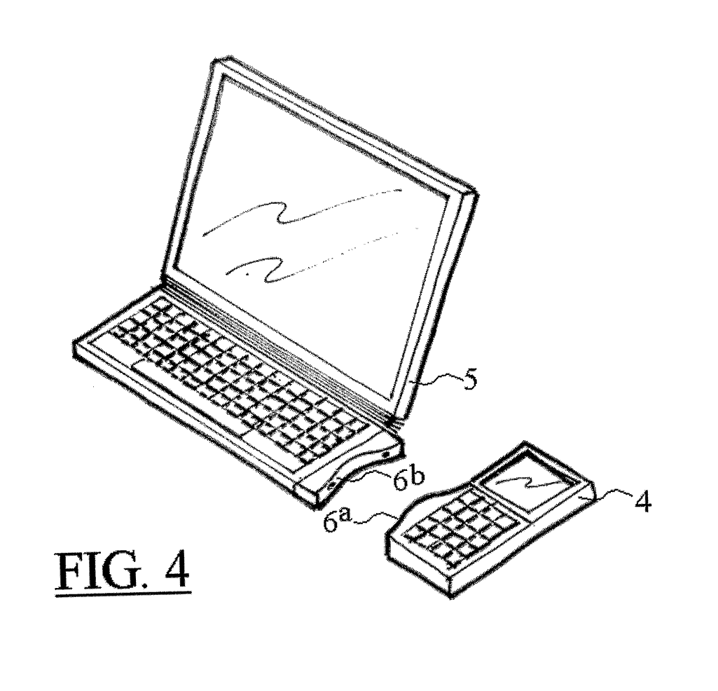

FIG. 4 shows another set of two cooperating modules.

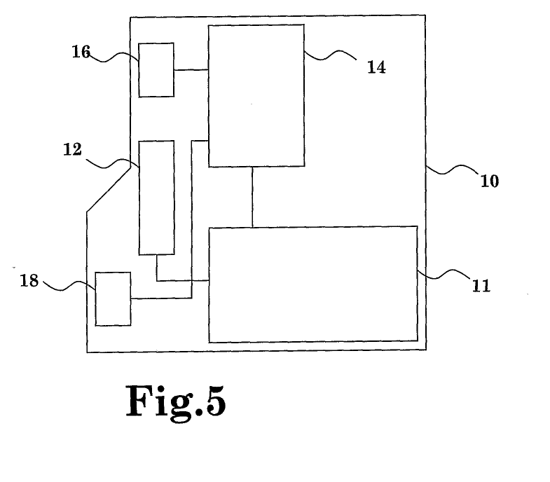

FIG. 5 shows a circuit of a module.

In FIG. 1 a communication system is shown which comprises two communication modules or terminals 1, which are enabled to mutually exchange data via a short-range wireless path which comprises e.g. one or (like in FIG. 1) two termination nodes 2. Each module 1 comprises a housing 3 which comprises an edge with an external shape which is—at least for a part 3a—explicitly arranged so as to be complementary to the shape of the cooperating module. The external shape 3a of the edge of the housing 3 and the location of the wireless nodes 2 are arranged thus that, when bringing the edges of the cooperating modules into each others direct vicinity, the nodes 2 of both cooperating modules 3 match too, viz. come into a position wherein they face each other. The nodes 2 may be unidirectional or bidirectional nodes, e.g. operating in the infrared domain, radio frequent domain or the (e.g. rather low frequent) magnetic/inductive domain.

The modules have self-complementary shape parts. If one modules is rotated over degrees the curved part of its edge shape becomes the same as that of the other module. Thus a set with any number of modules with a similar edge shape can be used so that their edge shapes all match the edge shape of all other modules in the set. This is because the self-complementary shape parts each comprise two curved or angled parts that fit with each other (e.g. the concave part and the convex part of the sine shaped edge of module A, or parts of edge of module B that contain the sharp angle and the obtuse angle of the skewed step of module B respectively). These parts are located such that, when a first one of these parts (e.g. the concave part) of a first module is brought into mated relation with a second one of these parts (e.g. the convex part) of a second module, then also the second one of these parts (e.g. the convex part) of the first module is brought into mated relation with the first one of these parts (e.g. the concave part) of the second module. Thus, the first and second one of the parts form a self-complementary curved or angled shape part. Such a self-complementary curved or angled shape part can also be formed from more than one pair of shape parts that match with corresponding pairs of similar shape parts on other modules, each pair e.g. being located at a different angle or offset

The modules 3 may comprise means (hardware/software), arranged to perform a default operation via the relevant short-range wireless path or paths as soon as the cooperating modules are brought into each others vicinity. The default operation may start automatically when the relevant module 3 detects the reception of a signal having a certain minimum signal strength or a code having a certain value, from the other side. The default operation may comprise an automatic handshake operation, which may be followed by further data transmission.

Preferably a minimum signal strength with which the strength of the signal is compared is set to a value that can only be achieved if the external shapes of the modules are in mated relationship. The use of the signal strength of the wireless communication signal has the advantage that no additional circuits are needed to receive or send signals to sense mating.

Mated relationship of modules may be defined e.g. that the modules must be so close together that no virtual (flat) plane exists that separates the modules (has one module entirely on one side and the other module entirely on the other side), or, alternatively when each point on the shape part of one module is at substantially a same distance (e.g. not at more than twice the distance of any other point) to a nearest point on the shape part of the other module, the distance being less than a maximum height variation of the shaped part (i.e. the maximum distance between the surface and a virtual flat plane for which such maximum deviation is as small as possible), and preferably less than two millimeters or ten millimeters.

FIG. 5 shows another embodiment wherein separate sensor elements 16, 18 are used to control mating of a module. The figure shows a module 10, with a main processing circuit 11, a wireless communication interface 12 (e.g. a bluetooth interface), a mating detector 14 and sensing elements 16, 18. Mating detector 14 is coupled to sensing elements 16, 18 to form a detection arrangement. Mating detector 14 is coupled to main processing circuit 11. Main processing circuit 11 is coupled to wireless interface 12.

Sensing elements 16, 18 provide for proximity sensing. They may be implemented for example as an infrared transmitter and receiver respectively, or as a radio frequency signal transmitter and receiver, or as a magnetic field generating coil and pick up coil, or as a pair of electrodes for generating an electric field and electrodes for picking up such an electric field for example.

Sensing elements 16, 18 are located to generate and pick up sensing signals, outside the housing of module 10 near the matching surface parts. When the external shape parts of a first and second module are in mated relationship sensing element 16 in one of the modules generates a signal that is pickup by the other sensing element 18 of the other module and vice versa. Mating detector 14 detects that the signal has been picked up and sends an activation signal to main processing circuit 11. In response main processing circuit 11 starts communication using wireless communication interface 12.

Sensing elements 16, 18 are configured so that at least one (and preferably both) of generating and picking up is performed locally, so that only adjacent the shape part of the housing sufficient signal strength can be detected to trigger the activation signal. A magnetic field generating coil in the first module may be located for example so that the magnetic field is generated outside the housing with its maximum strength at the location where a pick-up coil in the second module is positioned when the modules are in mated relationship and vice versa. An electric field generating electrode in the first module may be located for example so that the electric field is generated outside the housing with its maximum strength at the location where pick-up electrodes in the second module is positioned when the modules are in mated relationship and vice versa. An infrared source the first module may be located for example so that the infrared radiation outside the housing is directed at the location where an infrared detector is located in the second module is when the modules are in mated relationship and vice versa.

In another embodiment the function of the different sensing elements 16, 18 may be combined into one bidirectional sensing element located to sense at or near a point of symmetry of the shape part. In another embodiment switches may be used in the modules, located so that the switches are activated when the modules are in mated relationship. As mentioned the strength of the wireless communication signal, e.g. the bluetooth signal may be used for this purpose, but this requires that such a signal is active even before mating. If power consumption should be small, it is preferred to use a different type of sensing mechanism.

In an embodiment the main processing circuit 11 is configured to continue wireless communication regardless of whether the mated relationship is subsequently terminated. Thus, the mated relationship is used merely to activate communication and not as a state that should persist to maintain communication. It may be noted that this can be applied even if the modules are not self complementary.

In a further embodiment the communication is only started if mating detector 14 detects establishment of the mated relationship and subsequent termination of that relationship. Thus the user can use the communication when no longer concentrating on providing a mated relationship. In another embodiment at least one exchange of data that is directly or indirectly triggered by detection of the mated relationship is started independent of whether the mated relationship has been terminated, i.e. possibly also after termination of that relationship. It may be noted that this can be applied even the modules are not self complementary.

FIG. 2 shows schematically two different sets A and B of cooperating modules (two of each set shown), wherein both sets have a self-complementary shape parts. Each of the modules of one specific set comprises a housing which comprises an external shape which is explicitly arranged to match with the shape of another one of the cooperating modules of the same specific set. In FIG. 2 the housings of all modules of the first set A has a shape (at the side of the nodes) 3a and the housings of all modules of the second set B has a shape (at the side of the nodes) 3b, which intuitively leads users to couple modules of the first set or modules of the second set with each other.

Each one of the cooperating modules of one specific set A or B respectively comprises means which are arranged to perform a default operations as soon as said cooperating modules of the same specific set are brought into each others direct vicinity. The default operation may be (or may be not) representative for the relevant specific set A or B respectively of cooperating modules.

Preferably at least some circuits are provided that support communication between modules of the different sets. In one embodiment modules are provided that have the relevant shape parts of both sets, with corresponding detection arrangements, so that they can be used to activate communication with modules of both sets.

FIG. 3 shows a communication system, comprising two subsystems, formed by two sets of modules having mutual different shapes. The modules belonging to the respective subsystems are indicated by A and B.

It will be appreciated that the shapes shown in the preceding figures are merely examples of self-complementary shapes other shapes may be used, for example any shape that is symmetric under a rotation over 180 degrees, or over another integer fraction of 360 degrees (e.g. 30, 36, 40, 45, 60, 72, 90, 120, 180 degrees), i.e. 360/n, where n is an integer.

Finally, FIG. 4 shows a set of two modules, wherein the matching parts are not self complementary. One of the matching parts is concave and the other is convex. The modules may for example be an organizer like module 4 and a laptop like device 5 which can mutually cooperate by means of a short-range wireless path, via nodes in matching shapes 6a-6b. The complete system may comprise several organizer like devices 4 and/or laptop like devices 5 which can communicate with each other by means of the nodes in the specially shaped housing parts 6a and 6b of those cooperation devices.

In a further embodiment each module is provided with a first shape part and a second shape part, so that the first shape part can be matched with the second shape part on another module. In this case the modules are self complementary although the individual shape parts are not. Thus for example in this embodiment each module may have both a shape part shaped like shape 6a and a shape part shaped like shape 6b, provided with sensing elements to detect mated relationship. Thus all modules can be mated with all others without requiring self-complementary shapes. However, this requires more use of more surface area on the modules for mating purpose.

Basically a communication system is provided comprising at least two cooperating modules which are enabled to mutually exchange data via at least one short-range wireless path, each one of said cooperating modules (1, 4, 5) comprising at least one wireless termination node (2) which is fit to be part of the relevant short-range wireless path, moreover, each one of said cooperating modules comprising a housing (3) which comprises an external characteristic which is explicitly arranged to match with the characteristic of another one of said cooperating modules. In an embodiment the external characteristics are shape parts and in a further embodiment these are self-complementary. In another embodiment, said external characteristic is the relevant modules external shape (3a, 3b, 6a, 6b). In another embodiment, the external characteristic of the housing and the location of the wireless node or nodes being arranged thus that, when bringing said cooperating modules into each others vicinity the wireless node or nodes of said cooperating modules match too.

In another embodiment, each of said cooperating modules comprises at least one bidirectional node. In another embodiment, each of said cooperating modules comprising at least two unidirectional nodes. In another embodiment, each of said cooperating modules comprising one or more infrared nodes. In another embodiment, each of said cooperating modules comprising one or more radio frequent nodes. In another embodiment, each of said cooperating modules comprising one or more inductive nodes. In another embodiment, each of said cooperating modules comprising means which are arranged to perform at least one default operation via the relevant short-range wireless path or paths as soon as said cooperating modules are brought into each others vicinity. In another embodiment, one default operation is an automatic handshake operation. In another embodiment, comprises different sets (A, B) each of at least two cooperating modules, each one of the cooperating modules of one specific set comprising a housing which comprises an external characteristic which is explicitly arranged to match with the characteristic of another one of the cooperating modules of the same specific set. In another embodiment, each one of the cooperating modules of one specific set comprises means which are arranged to perform at least one default operation as soon as said cooperating modules of the same specific set are brought into each others vicinity. In another embodiment, said at least one default operation is representative for the relevant specific set of cooperating modules.

1. A communication system comprising a plurality of modules, each module comprising:
a wireless termination node for establishing a wireless communication path between the module and other ones of the modules for exchange of data,
an external housing with a first and second housing part having a curved and/or angled shape that is complementary to a curved and/or angled shape of a second and first housing part, respectively, of an external housing of another one of the modules,
a sensing arrangement to detect whether the first and/or second housing part is brought into a mated relationship with respect to a corresponding second and/or first housing part of another one of the modules and to trigger an exchange of data via the wireless communication path in response to said detection.

2. A communication system according to claim 1, wherein the first and second housing parts in each module are shaped and located such that a combination of the first and second housing part is self-complementary, such that the first and second housing parts of a first module can simultaneously be brought into mated relationship with second and first housing parts, respectively, of another one of the modules.

3. A communication system according to claim 1, further comprising a main processing circuit arranged to control said exchange of data, the main processing circuit being configured to start and continue the exchange of data independent of whether the mated relationship is terminated before a start of the exchange of data and/or termination of the exchange of data.

4. A communication system according to claim 1, wherein an external shape part of the housing and a location of the wireless node or nodes is arranged such that, when bringing said cooperating modules into the mated relationship a position of the wireless node or nodes of said cooperating modules match.

5. A communication system according to claim 1, comprising different sets each of at least two cooperating modules, each one of the cooperating modules of one specific set comprising a housing which comprises a self complementary external shape part which is explicitly arranged to match with the self complementary external shape part of another one of the cooperating modules of a same set, wherein shape parts for the different sets have mutually differing shapes.

6. A module for use in wireless exchange of data with other modules, the module comprising:
a wireless termination node for establishing a wireless communication path between the module and other modules,
an external housing with a housing part having a self-complementary curved and/or angled shape,
a detection arrangement arranged to detect whether the housing part is brought into a mating position with respect to a corresponding housing part of another module with said self-complementary curved and/or angled shape and to trigger an exchange of data by the wireless termination node in response to said detection.

7. A module according to claim 6, further comprising a main processing circuit arranged to control said exchange of data, the main processing circuit being configured to start and continue the exchange of data independent of whether the mated relationship is terminated before the start of the exchange of data and/or a termination of the exchange of data.

8. A module according to claim 6, wherein the module comprises at least one bidirectional node.

9. A module according to claim 6, wherein the module comprises at least two unidirectional nodes.

10. A module according to claim 6, wherein the module comprises one or more infrared nodes.

11. A module according to claim 6, wherein the module comprises one or more radio frequent nodes.

12. A module according to claim 6, wherein the module comprises one or more inductive nodes.

13. A module according to claim 6, further comprising a computing component which performs at least one default operation via the relevant short-range wireless path or paths as soon as said cooperating modules are brought into each others vicinity.

14. A module according to claim 13, wherein one default operation is an automatic handshake operation.

15. A method of operating a system of modules capable of communicating with each other via wireless communication, the method comprising:
providing at least two modules, each module including an external housing with a housing part having a self-complementary curved and/or angled shape;
detecting whether the housing part is brought into a mating relationship with respect to a corresponding housing part of another module with said self-complementary curved and/or angled shape;
triggering an exchange of data by a wireless termination node in response to said detection.
